(19) United States
(12) Patent Application Publication
(10) Pub. No.: US 2005/0168591 A1
(43) Pub. Date: Aug. 4, 2005

(54) Electronic camera with digital effect filter

(76) Inventor: Adolf Proidl, Vienna (AT)

Correspondence Address: PHILIPS INTELLECTUAL PROPERTY & STANDARDS, P.O. BOX 3001, BRIARCLIFF MANOR, NY, 10510, US

(21) Appl. No.: 10/508,563

(22) PCT Filed: Mar. 20, 2003
(86) PCT No.: PCT/IB03/01146

(30) Foreign Application Priority Data
Mar. 27, 2002 (EP) 02100310.8

(51) Int. Cl. H04N 5/228

(52) U.S. Cl. 348/222.1

(57) ABSTRACT

In an electronic camera (10) carrying means (72) for carrying digital filter means are constructed to enable an updating and/or expanding of the digital filter means in order to enable and provide a high-quality digital effect filter for photographing. Preferably, take-up means (70) are provided for taking up the carrying means (72) which are realized as a plug-in card (72).

The invention relates to an electronic camera comprising a digital filter.

Such an electronic camera is disclosed in Japanese Patent Application with Publication No. 04-081176 wherein the electronic camera is constructed as a so called electronic still camera. The electronic still camera is capable of modifying a generated digital image by means of a digital filter means. The digital filter means computes the effect one can get in conventional chemical photography if one takes the diaphragm completely open with only the focused object being sharp. The rest of the image is extremely blurred so that the focused object is highlighted.

The known electronic still camera provides a recording system for recording a digital image on a recording medium and a reproduction system for outputting a picture onto a display device of the known electronic still camera with the digital image being modified by the digital filter means as described above.

However, it is a drawback of the known electronic still camera that the digital filter means comprises only a limited functionality. It is another drawback of the known electronic camera that the digital filter means can only be applied after the recording of a digital image. A disadvantage of such a proprietary digital filter approach in general relates to a quality, creativity respectively of the effect of the digital filter means. Professional photographers are highly interested in creative and good-quality filter effects.

It is an object of the invention to eliminate the above-mentioned drawbacks and provide an improved electronic camera comprising digital filter means.

To achieve the object mentioned above, an electronic camera as described in the opening paragraph can be characterized as follows.

An electronic camera comprising:
photographing means for photographing an object and outputting image data;
image data processing means for processing the image data;
image data storing means for storing the processed image data;
carrying means for carrying at least one digital filter means which digital filter means are applicable to the image data, characterized in that the carrying means are constructed to enable updating and/or expanding the at least one digital filter means.

Thanks to the characteristic features of the invention it is achieved in a relatively simple way that an extended filter fuctionality and effects on an electronic camera can be used due to exchangeable and/or updateable digital filter means or digital filter data. It is another advantage that the digital filter means or digital filter data can easily be created by creative commercial artists or specialists.

In the embodiments according to the invention, it has been proved to be advantageous when means according to claim 2 are provided. An immediate digital filter means exchange can be performed with the carrying means e.g. when photographing.

In the embodiments according to the invention, if has further proved to be very advantageous when means according to claim 3 are provided. A digital filter means can then be chosen from a large selection.

It has further proved to be very advantageous in the embodiments according to the invention when means according to claim 4 are provided. This actually known measure is very advantageous within the embodiments of this invention.

The invention will be better understood with the following description explaining the physical basis of the invention based on the enclosed drawing showing a preferred embodiment of the latter as a non-limitative example of implementation.

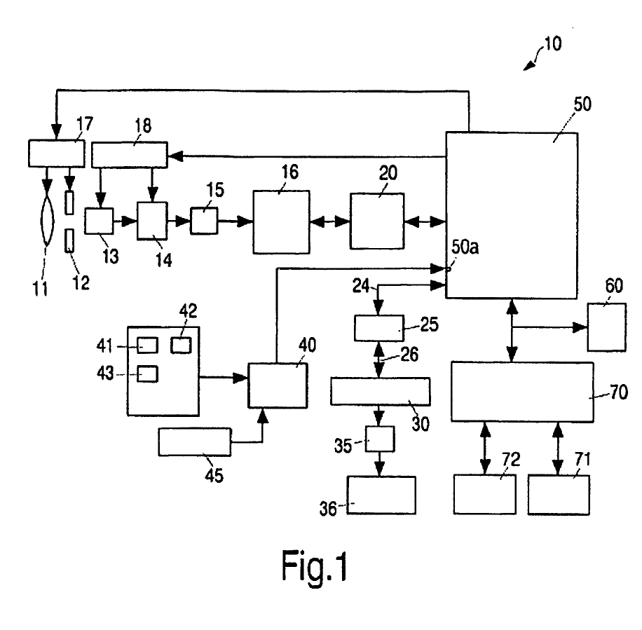

FIG. 1 shows a block diagram of an electronic camera in accordance with this invention.

It will be appreciated that the following description is intended to refer to specific embodiments of the invention selected for illustration in the drawings and is not intended to define or limit the invention, other than in the appended claims.

FIG. 1 is a functional block diagram showing the overall and electrical schematic structure of an electronic still camera 10 in the present embodiment of the invention. A CPU 50 is provided for controlling the entire electronic still camera 10 in particular the image sensing and processing.

An optical image obtained through an optical system comprising a lens 11, an iris stop 12 and others is formed on a light-sensitive surface of an image pickup element 13 which is a CCD in this case. Lens 11 and iris stop 12 are driven by a focus and iris driving circuit 17 respectively. The image pickup element 13 photoelectrically transfers the optical image formed on the light-sensitive surface into a charge amount and outputs analog image signals through transfer pulses from an image pickup element driving circuit 18. Noises in the analog image signal thus outputted are reduced through a CDS (correlative double sampling) processing conducted in a preprocessing circuit 14, then, gains are adjusted by AGC, and binary-coding processing for dynamic range extension is conducted. Then, the analog image signals are converted by A/D converter 15 into digital image signals which are then subjected to brightness processing and color processing in a first signal processing circuit 16, to be converted into digital video signals which are further outputted to an image memory 20. The image memory 20 is connected to the CPU 50 and has a storage capacity that corresponds to one frame. That is, if it is assumed that the image pick up element 13 has n rows×m columns of pixels, the image memory 20 has a storage capacity that corresponds to n×m pixels, and the pixel data of the individual pixels is stored at a corresponding location in the image memory 20.

A VRAM 25 is connected via an input bus 25 to the CPU 50, which VRAM 25 is used principally to display images on an LCD 36. The VRAM 25 is structured by a dual-port RAM so that the VRAM 25 can be written through input bus 24 and simultaneously read out through an output bus 26. The output bus 26 is further connected to a second signal processing circuit 30. Second signal processing circuit 30 includes a color separating unit and a matrix circuit (both not shown), so as to convert the image data read out of the VRAM 25 into luminance data and chrominance data. The luminance data and the chrominance data outputted from the second signal processing circuit 30 are converted into an analog luminance signal and chrominance signal by a D/A converter 35. The luminance signal and the chrominance signal from the D/A converter 35 are supplied to the LCD 36 provide on the electronic still camera 10 or to a TV monitor through an output terminal (the latter two not shown).

The electronic still camera 10 further comprises a card interface (I/F) 70 which is connected to the CPU 50 via a bus 65. Furthermore, an SRAM 60 is connected to the bus 65.

Furthermore, a memory card 71 and a digital filter card 72 comprising digital filter means are connected to the card interface 70, which cards 71, 72 both are pluggeable into separate slots. The card interface 70 is able to detect a presence of each of the cards 71, 72 and to output a card presence signal for each of the cards 71, 72 to the CPU 50. The card interface 70 satisfying the PCMCIA (“Personal Computer Memory Card International Association”) standard performs data input/output processing in accordance with the PCMCIA format used for the memory card 71.

The electronic still camera 10 further includes operating buttons such as a shutter button 45, a monitor on/off button 43, an erase button 42 and so on. An operating signal from the operating button is supplied to a system controller 40. The system controller 40 outputs a predetermined control signal depending upon an operating signal by the operating button 41-45. The control signal is converted into a serial signal to be supplied to an interrupt terminal 50a of the above stated CPU 50.

For example, when the shutter button 45 is depressed, the system controller 40 outputs a shutter signal so that the shutter signal is supplied to the interrupt terminal 5a of the CPU 50. In response thereto, the CPU 50 suspends the image pickup element 13 from being inputted reserved, respectively, so that a still picture signal is outputted from the image pickup element 13 upon the depression of the shutter button 45. Therefore, the VRAM 25 is finally written by the image data due to the depression of the shutter button 45. The CPU 50 reads out the image data written in the VRAM 25, and carries out a well-known JPEG compression to compress the image data. The compressed image data are transferred via the card interface 70 to the memory card 71. It should be noted that the compression of the image data can also be performed according to TIFF (“Tagged Image File Format”) or similar formats.

With the digital filter means on the digital filter card 72 digital images obtained as described above are modifiable, which means a new digital image is created as result of processing the pixels of the existing digital image. In addition, if the filter card is present, the CPU 50 reads out the uncompressed image data available in a dedicated storage area of the VRAM 25 and passes the data through the card interface 70 to the digital filter card 72 comprising the digital filter and transfers modified or filtered image data respectively, via the digital filter means to another dedicated area in the VRAM 25. The digital filter means in this case is realized as a simple feedback shift register. A well-known memory mapping method is used for the image data transfer to and from the digital filter. Each pixel in the filtered digital image is computed or modified as a function of one or several pixels in the original image, usually located near the location of the output pixel. Therefore, at least a number of lines has to be submitted to the digital filter before such an operation can be conducted. It should be noted that a digital filter means can be realized in a different manner such as a microcomputer in which digital filter data are stored, which digital filter data are applicable to the image data. Such an approach is well known to a man skilled in the art.

It should be noted that the filter card 72 may carry an indication to easily distinguish between different filter cards 72. Such an indication may be realized by a sign or via color.

In the electronic still camera 10 shown in FIG. 1, if the camera mode is set to a record mode by the camera mode selecting button 41 and if the monitor on/off button 43 is switched, the LCD 36 can be utilized as a viewfinder. In this mode, while the shutter button is not depressed, the image data obtainable by converting by the A/D converter 15 the progressive scan signals from the image pickup element 13 into digital data is supplied to the VRAM 25 via the first signal processing unit 16. The image data supplied to the VRAM 25 is outputted onto the output bus 26, hence displaying an image on the LCD 36. While the LCD 36 is utilized as a viewfinder, the digital filter process as mentioned above is performed and the LCD 36 displays the filtered or manipulated image data, respectively.

During a reproduction mode of the electronic still camera 10 set by the camera mode selecting button 41 image data stored on the memory card 71 is displayed on the LCD 36. The stored image data are then transferred from the memory card 71 to the VRAM 25 with a decompression being performed. A digital filter process as mentioned above can be conducted by means of the inserted filter card 72.

At another example of an electronic still camera according to the invention the filter card 72 comprises a plurality of different digital filter means or digital filters, respectively. In addition to the elements shown in FIG. 1 a filter selection button is embodied and connected to the system controller 40. Further, filter selection means are embodied at the CPU 50 which are constructed to transfer digital image data to and from a digital filter out of the plurality of digital filters on the digital filter card 72. The filter selection means are controlled by the filter selection button. It should be noted that a rotary switch or slide switch can be used for the filter selection.

The abovementioned approach of selecting a digital filter applies to digital filter means comprising so called not scalable or fixed filter effects respectively. Such a fixed filter effect is for example a sunset filter effect.

It should be noted that in distinction to the fixed filter effects scalable filter effects can be realized by a digital filter means. Such a scalable filter effect is for example a fog filter or a motion blur filter or a graded blue sky filter. In this case, the filter selection means are constructed to select an intensity of the filter effect. This means for example, on a digital filter card 72 intended to obtain a fog filter effect, a plurality of digital filter means are provided wherein each of the plurality of digital filter means has a different intensity of the fog filter effect. Similarly, with the motion blur filter e.g. the direction of the motion can be selected or with the graded blue sky filter the color intensity of the blue sky can be selected.

In a further example of an electronic still camera according to the invention a carrying means in the form of a non-volatile memory connected to the CPU 50 is provided instead of the filter card 72. The non-volatile memory stores digital filter means applicable to digital image data as mentioned above. The digital filter means are designed as an algorithm which can be executed by the CPU 50. While performing necessary calculations at the execution of such an algorithm intermediate results may be obtained which intermediate results can be stored in the SRAM 60. By means of a communication interface of the USB type (“Universal Serial BUS”), which communication interface is connected to the CPU 50, and a personal computer PC connected to the communication interface, the digital filter means can be modified to the nonvolatile memory.

It should be noted that a digital filter approach according to the invention is also applicable to an electronic camera wherein a plurality of pictures or images is taken up consecutively.

It should further be noted that instead of the CPU 50 a digital signal processor DSP can be used to control the electronic still camera 10.

1. An electronic camera (10) comprising:
photographing means (11, 12, 13, 14, 15) for photographing an object and outputting image data;
image data processing means (16, 50) for processing the image data;
image data storage means (20, 25, 71) for storing the processed image data;
carrying means (72) for carrying at least one digital filter means which digital filter means are applicable to the image data, characterized in that the carrying means (72) are constructed to enable updating and/or expanding the at least one digital filter means.

2. An electronic camera as claimed in claim 1, characterized in that the carrying means (72) are removable, take-up means for taking-up the carrying means (72) being provided therein.

3. An electronic camera (10) as claimed in claim 1, characterized in that connecting means are provided for connection to a database comprising digital filter data for updating and/or expanding the digital filter means by digital filter data.

4. An electronic camera (10) as claimed in claim 1, characterized in that filter selection means for selecting digital filter means are provided.

5. An electronic camera (10) as claimed in claim 4, characterized in that the digital filter means comprise a variety of filter effects.

6. An electronic camera (10) as claimed in claim 4, characterized in that the filter selection means are constructed for selecting an intensity of a filter effect of the digital filter means.
